(19) United States
(12) Patent Application Publication
(10) Pub. No.: US 2009/0250383 A1
(43) Pub. Date: Oct. 8, 2009

(54) Flotation Method

(76) Inventors: Michael Francis Young, Queensland (AU); Stephane Girard, Queensland (AU); Joan Ann Cowburn, Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/085,638

(22) PCT Filed: Nov. 17, 2006
(86) PCT No.: PCT/AU2006/001732

§ 371 Date: Mar. 31, 2009

(30) Foreign Application Priority Data
Dec. 6, 2005 (AU) 2005906838

(51) Int. Cl. B03D 1/24

(52) U.S. Cl. 209/159

(57) ABSTRACT

A flotation method in which a liquid or slurry is fed to a downcomer (20) where it forms a region of high void fraction which moves out of the downcomer (20) into a vessel (10) in which a froth rises and liquid or slurry falls, characterized in that the liquid or slurry is fed to the downcomer (20) with a jet velocity as it exits an orifice and enters a free jet zone of less than 8 metres/second.

### FIELD OF THE INVENTION

The present invention relates to a flotation method.

### BACKGROUND TO THE INVENTION

Flotation is a well known technique for separating particulate material from slurry suspensions. In flotation, the slurry containing the particles is treated with reagents to render certain particles hydrophobic (water repellent) and a gas, typically air, is emitted into the suspension in the form of small bubbles. When the hydrophobic particles come into contact with the bubbles, the hydrophobic particles adhere to the bubbles. Due to hydrostatic forces, the bubbles, together with adherent particles, rise upwardly through the slurry to form a froth. The froth containing the adherent particles is then removed as a concentrate or product, whilst any hydrophilic (water loving) particles are left behind in the slurry phase and flow out with the slurry phase as tailings. Flotation processes can be applied to suspensions of minerals in water, suspensions of coal in water, to the removal of oil droplets from water, as well as to fibrous or vegetable matter such as paper fibres, bacterial cells and the like. In addition to adding reagents to the slurry to render the particles hydrophobic (such reagents are called collectors), frothing agents are also often added in order to assist in establishing a stable foam.

Conventional flotation is conducted in tanks or vessels. Such tanks or vessels are provided with an impeller which stirs the slurry and assists in maintaining the particles in suspension. Air is normally admitted to the flotation tank through the impeller. The impeller has three major functions:
to create bubbles;
to make bubbles and particles collide and attach to each other; and
to keep the particles in suspension.

As the particles in the flotation feed become coarser, the impeller speed is generally increased to keep the particles in suspension. In conventional flotation cells, the impeller is immersed inside the flotation tank and forms an integral part of the cell. Consequently, it is not possible to adjust impeller speed in order to affect one of its functions (such as particle suspension) without affecting the other functions (such as bubble creation and bubble/particle collision/attachment).

An alternative flotation apparatus is a self aspirated pneumatic flotation machine. Such devices have a motion of slurry passing through a mixing arrangement, where the motion of the slurry creates a vacuum that causes air under atmospheric pressure to aerate the slurry. These flotation devices are commercially available under the names of Pneuflot® Cells, Imhoflot V-cell, Imhoflot G-cell and Jameson Cells. The Jameson Cell is described in U.S. Pat. No. 4,938,865 and in Australian Patent No. 677542. The entire contents of both of these patents are incorporated herein by cross-reference. The flotation apparatus described in these patents are commercially available under the trade name “Jameson Cells” (the cells being named after their inventor, Professor Graeme Jameson). Jameson Cells have been widely commercialized and have been used in the flotation of coal fines and coal slimes, mainly for the purpose of cleaning the coal, flotation of base metals, of non-sulphide gangue, flotation of potash, graphite, treatment of liquids in the electro-winning of copper, cobalt, zinc, nickel and platinum (primarily by removing organics from the loaded leach liquors), for recovering organic phase from organic/raffinate mixtures resulting from solvent extraction processes, and for the recovery of bitumen and other petroleum hydrocarbon mixtures from sands and silts as recognised in the oil sand industry (also known as tar sands and bituminous sands).

The Jameson Cell includes a downcomer (or a plurality of downcomers), typically in the form of a generally vertical column. Compared to mechanical flotation cells, the functions of producing bubbles and particle bubble collision/attachment in a Jameson Cell are done separately inside the downcomer. The different hydrodynamic regions that constitute the Jameson Cell downcomer are shown in FIG. 2 and consist of the free jet, induction trumpet, plunging jet, mixing zone, and pipe flow zone. The following steps occur within the downcomer, which are explained in more detail below:
The jet created by the slurry passing through the orifice promotes the inducement of air into the downcomer
The shearing action of the jet generates fine bubbles and transports them through the mixing zone
The particles and the bubbles collide and attach to each other and subsequently travel down the downcomer through the pipe flow zone
Bubbles are removed by hydrostatic pressure from the downcomer creating a vacuum for further air entrainment

The Free Jet

The slurry feed is delivered to the nozzle under pressure and results in a free jet of pulp being created as it passes through the orifice plate. As the free jet travels through the downcomer, contact with air results in a slight slowing of the jet, minor expansion of the jet diameter and undulations upon the jet surface, which entrain a small amount of air.

The Induction Trumpet

The free jet impinges on the slurry mixture within the downcomer and the pressure of the impact creates a depression on the slurry surface, called the induction trumpet. Due to the fluted entry shape of the induction trumpet, air is channeled into the area at the base of the free jet. The free jet passes through the induction trumpet carrying with it this layer of entrained air. Additionally, the periodic collapse of the induction trumpet results in further air entrainment.

The Plunging Jet

Once the jet enters the main body of slurry in the downcomer through the bottom of the induction trumpet it is referred to as the plunging jet. The high shear rate of the plunging jet results in the entrained layer of air being broken down into a multitude of small bubbles, typically of <500 μm diameter, which are carried down the downcomer length.

The Mixing Zone

The plunging jet creates a region of intense energy dissipation and turbulence where momentum is transferred to the surrounding mixture and expands to occupy the downcomer cross section, creating re-circulating eddies of aerated pulp. This region of jet dissipation is known as the mixing zone and is defined as the downcomer volume occupied by (i) the slurry inside the submerged jet below the induction trumpet and (ii) the body of re-circulating slurry between the submerged jet and the downcomer wall. Within the mixing zone ongoing bubble coalescence and bubble creation continues to occur.

The Pipe Flow Zone

Beneath the mixing zone is a region of uniform multi-phase flow known as the pipe flow zone. Because the downward velocity counteracts the upward buoyancy of the bubbles, the bubbles pack together to form a moving expanded bubble bed of high void fraction. The pipe flow zone is characterised by a bubbly flow at lower air rates and moderately churn-turbulent flow at higher air rates.

As mentioned above, Jameson Cells are described in U.S. Pat. No. 4,938,865 and Australian Patent No. 677542. Australian Patent No. 677542 states that the velocity of the slurry jet in the downcomer preferably is about 15 metres/second, with the minimum velocity of the jet entering the downcomer being 8 metres/second. In practice, commercial Jameson Cells are typically operated with a jet velocity in the downcomer of 15 to 18 metres/second. Conventional wisdom is that downcomer jet velocities in the order of 8 to 17 metres/second are required in order to:
(a) entrain sufficient quantities of air to produce a large number of small bubbles in the downcomer; and
(b) provide high shear to obtain good mixing of the air and slurry in the mixing zone of the downcomer.

Jameson Cells have proven to be commercially successful and to provide good recovery, particularly for fine particles. However, due to the highly turbulent conditions in the downcomer, increased detachment of coarse particles from the bubbles has been observed. In some instances, this has resulted in a lower recovery of coarse particles from the flotation process.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

Any reference to publications cited in this specification is not an admission that the disclosures constitute common general knowledge in Australia.

### BRIEF DESCRIPTION OF THE INVENTION

The present invention provides a flotation method in which a liquid or slurry is fed to a downcomer where it forms a region of high void fraction which moves out of the downcomer into a vessel in which a froth rises and liquid or slurry falls, characterized in that the liquid or slurry is fed to the downcomer with a jet velocity as it exits an orifice and enters a free jet zone of less than 8 metres/second.

The velocity of the jet is determined by the volumetric flowrate of slurry being fed into the downcomers and the open area of the orifice or slurry lens. The invention can treat similar volumetric flowrates as the Jameson Cell currently marketed by Xstrata Technology. This is done by increasing the size of the orifice and regulating the slurry flow either by careful process design or by controlling the speed of a delivery pump.

Preferably, the slurry jet velocity falls within the range of 1 to 7.5 metres/second, more preferably within the range of 1.5 to 7 metres/second, even more preferably within the range of 2 to 6.5 metres/second.

The present invention is based upon the surprising discovery that adequate entrainment of air and subsequent mixing of the air and liquid or slurry in the downcomer mixing zone can occur even by using liquid or slurry jet velocities in the downcomer that are significantly lower than the liquid or slurry jet velocities disclosed in Australian Patent No. 677542 and significantly lower than the liquid or slurry jet velocities used in any commercial installation of Jameson Cells.

In a preferred embodiment, the method of the present invention is conducted in a flotation apparatus as described in U.S. Pat. No. 4,938,865 or Australian Patent No. 677542, or in an apparatus manufactured and sold by Xstrata Technology under the market name “Jameson Cells”. However for those skilled in the art would appreciate that the principal of this invention is applicable to any self induced pneumatic flotation device as previously described.

In one embodiment, a slurry is fed to the downcomer and the slurry consist of a mixture of particulate material and liquid, the froth in the vessel contains predominantly adherent, hydrophobic particles and the slurry in the vessel contains predominantly hydrophilic tailing particles.

In another embodiment, a liquid is fed to the downcomer and the liquid includes organic material and the froth contains organic material. In this embodiment, the liquid fed to the downcomer may be a two phase mixture of organic material and raffinate (or organic and electrolyte) from a solvent extraction process.

In another embodiment, the slurry fed to the downcomer includes a three phase mixture of bitumen, water and particulate solids, as characterised in the oil sand industry.

In preferred embodiments of the present invention, the liquid or slurry is fed into the downcomer through a restriction orifice or a slurry lens at a velocity of less than 8 m/s. The downcomer is suitably in the form of a column. The downcomer is preferably a vertical column. The jet of liquid or slurry preferably enters the downcomer in the form of a downwardly facing slurry jet.

For convenience and brevity of description, the description of the present invention hereunder will make reference to using a slurry as the feed material. However, it will be appreciated that the present invention should not be considered to be limited to use with slurries and the present invention can also be used to treat liquids that do not necessarily contain solids or particulates.

Suitably, the jet created by the slurry passing through the slurry lens promotes the inducement of air into the downcomer and the shearing action of the jet generates fine bubbles and transports them through the mixing zone. Particles and the bubbles collide and attach to each other and subsequently travel down the downcomer through the pipe flow zone where bubbles are removed by hydrostatic pressure from the downcomer creating a vacuum for further air entrainment

The flow rate of air into the downcomer is controlled to sustain the vacuum by use of a flow control device, with the volume of air being entrained into the downcomer and being discharged from the downcomer being equal to that air flowing into the downcomer. Suitably, a flow control valve may be used to regulate the amount of air entering the downcomer.

### BRIEF DESCRIPTION OF THE DRAWINGS

FIG. 1 is a schematic diagram of a flotation cell suitable for use in the method of the present invention;

FIG. 2 is a schematic diagram of a downcomer used in the flotation cell shown in FIG. 1, with the downcomer shown in FIG. 2 on an expanded scale;

FIG. 3 is a graph of percentage recovery vs particle size for different jet flow rates; and

FIG. 4 is a graph of percentage recovery vs particle size for different jet flow rates at a different APR than that of the Example of FIG. 3.

### DETAILED DESCRIPTION OF PREFERRED EMBODIMENTS

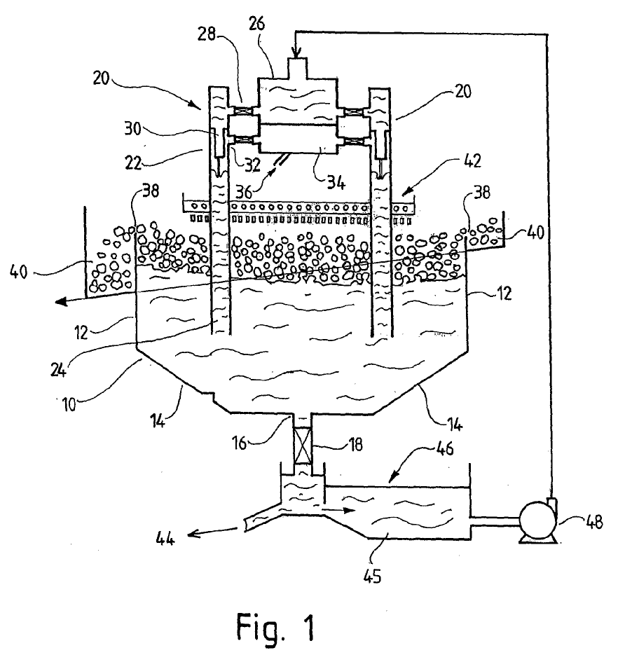

The flotation cell shown schematically in FIG. 1 is an example of a Jameson Cell, as manufactured and sold by Xstrata Technology. Jameson Cells are described in more detail in U.S. Pat. No. 4,938,865 and Australian Patent No. 677542, the entire contents of which are incorporated herein by cross-reference.

The flotation cell shown in FIG. 1 comprises a vessel 10. Vessel 10 has generally vertical side walls 12 and sloping lower walls 14. The vessel 10 has an outlet 16 at a bottom end thereof. A control valve 18 to regulate the level in the vessel 10. It will be appreciated that control valve 18 also controls the rate of discharge through outlet 16.

The vessel can include a single of a plurality of downcomers 20. Most industrial applications include a plurality of downcomers, and this sections is written as such.

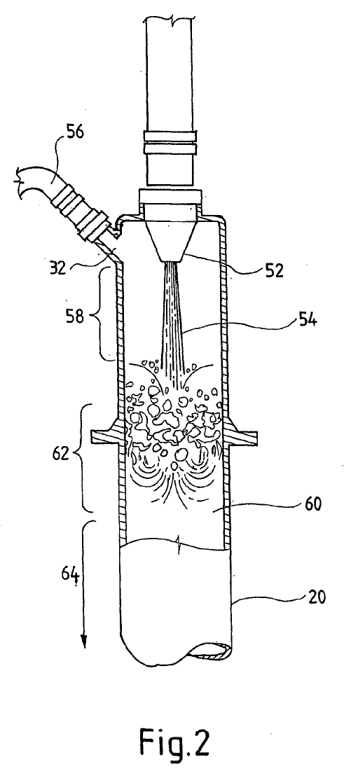

Each downcomer includes a generally vertically oriented column 22 having a lower outlet 24 located within the vessel 10. Feed slurry travels from manifold 26 into the respective downcomers 20 via flow passage 28. The feed slurry then passes through a slurry lens 30. The feed section of the downcomer 20 will be described in greater detail with reference to FIG. 2.

The feed slurry, which consist of a mixture of particulate material and water, is injected into the downcomer in the form of a slurry jet. The upper section of each downcomer 20 also includes an air inlet 32 that takes air from an air manifold 34. Air manifold 34 has an air inlet 36. Air inlet 36 may be regulated to regulate the amount of air admitted into the manifold 34, and hence into the downcomers.

When feed slurry is fed to the downcomers 20, air is entrained by the slurry jet and a bed of foam is formed in the downcomers. This foam travels down along the downcomer and exits the lower outlet 24. It is this flow out of the downcomer which causes a vacuum, which in turn induces more air into the downcomer.

The foam then moves into the vessel 10. In the vessel 10, the bubbles and predominantly any adherent particles move upwardly while the slurry comprising predominantly of tailing particles settles downwardly. Thus, in the vessel 10, a slurry phase and a froth phase are established. The froth rises to a level where it extends above a weir 38. The froth then moves over the weir 38 into a launder 40. The froth is recovered from launder 40. This also recovers any adherent particles, which are typically designated product particles. To improve the operation of the apparatus shown in FIG. 1, wash water supplied through wash water sprays or trays 42 may be used to wash undesired particles from the froth in the vessel 10.

As mentioned above, the slurry comprising predominantly of tailing particles settles in the vessel 10 and are removed via outlet 16. A portion of the slurry comprising predominantly of tailing particles are sent to tailings 44. Another portion of the tailings particles and slurry leaving through outlet 16 are recycled to a feed sump 45. In feed sump 45, fresh feed slurry 46 is mixed with recycled slurry. This slurry mixture is then pumped via pump 48 to the, feed manifold 26.

The upper part of each downcomer 20 is shown in more detail in FIG. 2. In FIG. 2, slurry is fed via conduit 50 to a slurry lens 52. Slurry lens 52 has an outlet that enters into downcomer 20. This outlet is typically in the form of an orifice. As shown in FIG. 2, the slurry leaving the outlet of slurry lens 52 forms a downwardly directed slurry jet 54.

The upper part of downcomer 20 also includes the air inlet 32. Air inlet 32 is connected via conduit 56 to air manifold 34.

The slurry jet 54 created by pumping the slurry through the slurry lens induces the entrainment of air. This occurs in the free jet zone 58.

During steady state operation of the downcomer, the downcomer 20 is partially filled with a bed of foam 60. The jet of slurry 54 and entrained air impacts into the bed of foam 60. The shearing action of the jet into the column of foam generates fine bubbles in the mixing zone 62. The bubbles and particles in the slurry collide with each other and the particles attach to the bubbles. The bubbles in particles flow to the pipe flow zone 64, whereafter they flow down the downcomer 20 and out of the outlet 24 into vessel 10.

Conventional operation of commercially installed apparatus similar to that shown in FIGS. 1 and 2, utilises a jet velocity for the slurry jet 54 of between 15 and 17 metres/second. Australian Patent No. 677542 specifies that the general operating velocity of the slurry jet 54 should be about 15 metres per second, with the minimum velocity of the jet 54 entering the downcomer being 8 metres/second. However, actual operation or testing of similar flotation cells at slurry jet velocities of less than 11 metres/second has never been reported.

The present applicant has surprisingly discovered that satisfactory air entrainment and shearing to produce bubbles and an adequate foam can be obtained if the slurry jet has a jet velocity of less than 8 metres/second. This result is completely unexpected and flies in the face of conventional wisdom regarding the operation of such flotation cells. Not only has the present applicant discovered that adequate air entrainment and bubble/foam formation can occur at these unexpectedly low slurry jet velocities, as a further benefit, the reduction in turbulence in the downcomer, reduces detachment of coarser particles from the bubbles, which thereby increases the recovery of desired particles from the process.

That the present invention is completely contrary to conventional wisdom as to the operation of such flotation cells can be demonstrated by the manner in which the present invention was made. The present inventors were conducting experimental work on a test rig when they inadvertently used a faulty flow meter to conduct experimental runs at what was thought to be a slurry jet velocity of 12 metres/second. However, it was subsequently discovered that the flow meter was reading higher than the actual flow rate such that the actual jet velocity being used in the experimental work was in the order of 2.5 to 7.5 metres/second rather than the 9 to 12 metres/second originally intended for the experimental runs. When the metallurgical analysis come back with positive results the applicants conducted further work to verify the results and further verify the present invention.

The other beneficial finding arising from this testwork was the reduction of the power draw required to pump at lower jet velocities. While it was expected from previous work, when jet velocities of 11 m/s were used that there was a slight reduction of power draw, the absolute power reduction was not realised until the results of this testwork was scaled to the actual layout of a coal wash plant. In effect, in typical coal operations, the head of pulp between the feed pump and the Jameson Cell distributor is in the order of several tens of meters. Consequently, the impact of a change in feed pressure is more significant when a larger delivery pulp head is assumed.

For instance from the test results, at 5 m/s jet velocity, the 30KW motor drew 15 Amps, while under designed velocities of 15 m/s it was found to be 18 Amps. In plant operating practice, the flotation cells are located anywhere between 20 to 35 meters up in the plant for processing reasons. When the operating conditions obtained in the testwork are scaled up to full-scale equipment this translates to 30 to 45 m head at a feed pressure of 100 kPa, this pressure was that achieved at 15 m/s during the test program. The actual power consumptions from the testwork, and the scaled up power consumptions for different jet velocities, are shown in the tables below:

TABLE 1
Actual Results from Testwork

| | Actual Power | Difference in Power |
|---|---|---|
| Jet Velocity | Consumption (KW) | Consumption |
| m/s | 1/s | % |
| 15.1 | 7.43 | — |
| 8.1 | 7.22 | 2.8% |
| 5.65 | 6.23 | 16.2% |
| 3.25 | 5.89 | 20.7% |

TABLE 2
Scaled Up Results Based on Testwork for Full Scale Plant

| | | Pump | Power | Power | | Difference in | Difference in |
|---|---|---|---|---|---|---|---|
| Jet | | Delivery | Consumed | Consumed | Assumed | Power | Power |
| Velocity | Flow | Head | on Water | on Slurry * | Slurry s.g. | Consumption | Consumption |
| m/s | l/s | m | kW | kW | kg/m3 | kW | % |
| 15.1 | 417 | 30.7 | 159 | 196.5 | 1.03 | — | — |
| 8.1 | 417 | 22.9 | 119 | 147.1 | 1.03 | 49.4 | 25% |
| 5.65 | 417 | 21.6 | 112 | 138.4 | 1.03 | 58.1 | 30% |
| 3.25 | 417 | 20.5 | 107 | 132.3 | 1.03 | 64.3 | 33% |

* denotes kW on water × s.g. × 1.2

This reduction of 33% equated to a significant power saving of 6 cents per tonne of clean coal produced, which for a typical coal mine in the Bowen Basin region of Australia, at current prices, would reduce total operating costs of the flotation circuit by over 10%, translating to over $160,000 per annum.

### EXAMPLES

The present invention was tested on coal through a pilot plant Jameson Cell located in the Bowen Basin of Queensland. The Jameson Cell had an industrial sized downcomer, 280 mm in diameter, situated in a cell 1.6 m in diameter. A bleed off stream from the processing plant fed the Jameson Cell. The pilot cell had a variable speed pump, as well as several different sized slurry lenses, which permitted different jet velocities in the downcomer to be tested. A valve and flowmeter was connected to the air inlet, that permitted varying the air to pulp ratio. The air to pulp ratio, or APR, is the measure of the volumetric flowrate of air that is mixed with the volumetric flowrate of slurry. Hence an APR of 1 implies there is an equal volume of air mixed with an equal volume of slurry. Industrial sized Jameson Cells have an APR ranging from 0.7 to 1.5, although this testwork confirmed that an APR of 1.7 can be successfully used in a Jameson Cell.

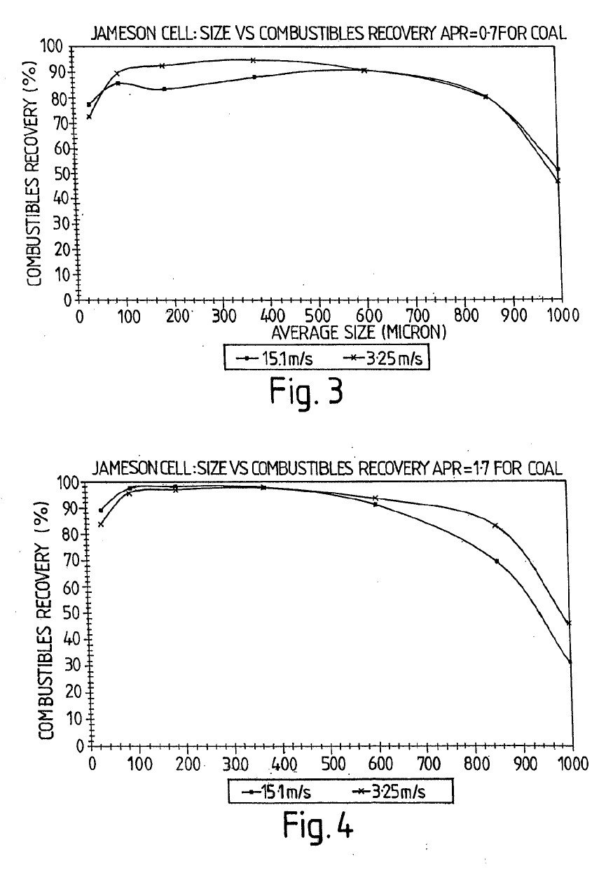

In the testwork, it was highlighted that there was a significant increase of coal recovered from 100 to 600 μm, at a jet velocity of 3 m/s, compared to the normal design value of 15 m/s when the APR was 0.7, as shown in FIG. 3.

FIG. 4 displays similar results when the APR was increased to 1.7. In this situation there was a significant increase in coarse coal recovery for sizes greater than 600 μm.

Those skilled in the art will appreciate that the present invention may be susceptible to variations and modifications other than those specifically described. It will be understood that the present invention encompasses all such variations and modifications that fall within its spirit and scope.

1. A flotation method in which a liquid or slurry is fed to a downcomer where it forms a region of high void fraction which moves out of the downcomer into a vessel in which a froth rises and liquid or slurry falls, characterized in that the liquid or slurry is fed to the downcomer with a jet velocity as it exits an orifice and enters a free jet zone of less than 8 metres/second.

2. A flotation method as claimed in claim 1 wherein the slurry jet velocity falls within the range of 1 to 7.5 metres/second.

3. A flotation method as claimed in claim 1 wherein the slurry jet velocity falls within the range of 1.5 to 7 metres/second.

4. A flotation method as claimed in claim 1 wherein the slurry jet velocity falls within the range of 2 to 6.5 metres/second.

5. A flotation method as claimed in claim 1 wherein a slurry is fed to the downcomer and the slurry consist of a mixture of particulate material and liquid, the froth in the vessel contains predominantly adherent, hydrophobic particles and the slurry in the vessel contains predominantly hydrophilic tailing particles.

6. A flotation method as claimed in claim 1 wherein a liquid is fed to the downcomer and the liquid includes organic material and the froth contains organic material.

7. A flotation method as claimed in claim 1 wherein a slurry is fed to the downcomer and the slurry fed to the downcomer includes an oil sand, tar sand or bituminous sand and the slurry comprises a three phase mixture of petroleum hydrocarbons, water and particulate solids.

8. A flotation method as claimed in claim 1 wherein the liquid or slurry is fed into the downcomer through a restriction orifice or a slurry lens.

9. A flotation method as claimed in claim 1 wherein the jet of liquid or slurry enters the downcomer in the form of a downwardly facing slurry jet.
